(19) United States
(12) Patent Application Publication
(10) Pub. No.: US 2023/0385038 A1
(43) Pub. Date: Nov. 30, 2023

(54) SHARING COMPONENTS AMONG APPLICATIONS METHOD FOR WEB APPLICATION DEVELOPMENT

(71) Applicant: CloudBlue LLC, Irvine, CA (US)

(72) Inventors: Anatolii KOLESOV, Moscow (RU); Dmitry NOZDRIN, Moscow (RU); Viacheslav DUBINSKII, Barcelona (ES)

(21) Appl. No.: 18/177,723

(22) Filed: Mar. 2, 2023

Related U.S. Application Data
(63) Continuation-in-part of application No. 17/824,563, filed on May 25, 2022.

(51) Int. Cl. G06F 8/38; G06F 9/455

(52) U.S. Cl. CPC G06F 8/38; G06F 9/45508

(57) ABSTRACT

Systems and methods for creating and integrating a shared component application into a host platform. The systems and methods include creating and integrating a shared component into a host platform, wherein the microservice application of the host platform comprises the shared component and a microservice application, communicating, to a UX development platform, a request corresponding to shared component (SC) application, communicating the SC to a microservice application development platform, as a microservice shared component, generating, by the microservice application development platform, a microservice shared component package based on a shared component, and integrating the microservice shared component package, wherein an application is integrated utilizing the microservice shared component based on the request.

### CROSS REFERENCE TO RELATED APPLICATION

The present application is a continuation in part (CIP) of U.S. patent application Ser. No. 17/824,563, filed May 25, 2022, the disclosure of which is hereby incorporated by reference herein.

### TECHNICAL FIELD

This invention relates to a method and a standard for application packaging and integration, and, more particularly, to application resource integration and deployment into a cloud.

### BACKGROUND

Computer systems present some challenges with regard to developing and installing updates and patches to hosted web applications. Software as Service (SaaS) web applications are integrated into systems by a vendor using special delivery and installation packages. However, if the vendor needs to integrate/deploy his application into a cloud, he will have to repeat all integration operations for each host or hosting platform several times. The hosts and the hosting platforms have applications that control the host or the hosting platforms. These applications make it very difficult and expensive to integrate external (third party) applications or web services.

Currently, integration of applications into hosts and hosting platforms is implemented by a controller. In case of a cloud system. A cloud (or cloud server) is a software-hardware combination of a host provider, which provides for functionality of external applications in its client's accounts.

In the field of cloud computing platforms, there exists an inefficiency of creation and deployment of client applications in conjunction with platform form operations. For example, cloud computing platforms may encounter problems related to effective application development and/or host deployment. Software as Service (SaaS) web applications are generally developed in a rigid association with a platform host. All processes relating to new applications in development are rigidly tied to platform host stacks deployment. Such method brought inconveniences and time losses in common with background related to necessity to resolve problems with applications on a core level.

The main disadvantage of conventional technologies is that, during a new application creation and deployment, a platform host is required to communicate packages having indefinite testing environment inside a package during application development. Moreover, the conventional technologies require excess deployment time, and a continuous interne connection is required during application creation. Accordingly, there is a need in the art for an efficient and inexpensive method for integration of the application itself, application updates and patches into a cloud platform host.

### BRIEF SUMMARY OF THE INVENTION

Embodiments described herein provide for shared component development. Specifically, embodiments disclose systems and methods for creating and integrating a shared component application into a host platform. The systems and methods can include communicating, to a UX development platform, a requirements package corresponding to a microservice frontend application; generating, by the UX development platform, a mockup package based on the requirements package; communicating the mockup package to a microservice frontend development platform, to a microservice frontend application; generating, by the microservice application development platform, a microservice frontend application package based on the mockup package; and integrating the microservice frontend application package, wherein a vendor application is integrated utilization the microservice frontend application based on the requirements package.

Conventionally, a frontend developer may encounter several challenges developing separated from the whole platform microservice to be used in a platform host as a part of multi microservice environment. Developing microservice via platform host raises supplementary development costs including deployment and sandbox adjustment (i.e., to the stack and platform host). Even minor changes to microservice code can necessitate deployment of all code to a stack again, resulting in transport loss. Frontend developers are usually provided with requirements for UI (User Interface) elements (buttons, fonts, colors, and others) and implementing each time from the scratch. The developer has to take into account many aspects in addition to writing the core of the business task itself of: how the microservice should appear with respect to the application itself, and how the microservice may appear and function in the common interface (platform host) and compliance with a single experience.

In some embodiments, SCD methods and systems can include a local microservices development mode that functions independently from a platform host, as described in detail in U.S. patent application Ser. No. 17/824,563, which is incorporated by reference in its entirety herein. In some embodiments, SCD methods and systems can additionally include processes for mockup and tokenization, i.e., tokens maintained in a unified library of widgets, for example, supported independent from a specific application and available to a frontend developer. In some embodiments, SCD methods and systems can further include interaction of microservice with the external world. For example, SCD methods and systems can enable communication between the shared component in development with other microservices, the host itself, the Representational State Transfer (REST) request system, unit testing, application debugging, simulation of communication before host deploys, etc.

In some embodiments, SCD methods and systems can also include the use of specific cloud framework(s) as part giving everything needed to frontend developer and getting back the result as application, integrated part of the process. The framework preliminary separates new microservice (web application) to specific program layers. According to embodiments described here, task resolution is achieved effectively by good organization of communication among different parts of “blocks” involved into web application creation process overall. Thus, faster application readiness, improved testing and debugging, and reduced costs of application development can be obtained.

Such approach allows to decrease the time of frontend developer spent to a new microservice, allows him to be lower skilled. SCD systems and methods require a developer only to combine software layers, do debugging process and further deploy to a stack and a platform host a workable microservice. Specific REST-Store vertical details provide effective frontend-backend connection of the microservice developed described below allowing developer use one and the same code for such modes as local development (with emulated data transport level), unit testing and in production (runtime).

According to embodiments of the present invention, Systems and Methods for Shared component Development (SCD) are provided to improve application development process. The SCD solution effectively addresses the above-mentioned technical problems, providing an independent application creation process and efficient application deployment to a platform host minimizing downtime, on a platform host core level.

SCD systems and methods are provided for creating, sharing, and integrating a vendor application. Systems and methods for application development and deployment can include communicating, by a host platform, a framework package corresponding to an application framework, wherein the framework package comprises a software abstraction for providing generic functionality in developing a vendor application, receiving, by the host platform, an application package corresponding to a vendor application, wherein the application package comprises a plurality of metadata files, control method descriptions, and content files, and integrating the application package to generate an integration of the vendor application based on the application framework.

According to some embodiments, SCD systems and methods differ from previous prior art technologies by creating and integrating a shared component application into a host platform. According to some embodiments systems and methods include creating and integrating a shared component into a host platform, wherein the microservice application of the host platform comprises the shared component and a microservice application, communicating, to a UX development platform, a request corresponding to shared component (SC) application, communicating the SC to a microservice application development platform, as a microservice shared component, generating, by the microservice application development platform, a microservice shared component package based on a shared component, and integrating the microservice shared component package, wherein an application is integrated utilizing the microservice shared component based on the request.

According to some embodiments, a shared component lifecycle methodology comprises a unique process for sharing one platform application (e.g., a component) and using it in another. Embodiments of a system for Shared Component Development (SCD) can include a Shared Component (SC) from an application that wants to use a component from another application. In some embodiments, an SCAS can include a first device and a second device. A first device can be a server, such as a host computer. A second device can be a computing device on which an application is developed. An SCD can commence a step that performs a component download process. A first device can receive from the second device a request to download the application to the second device. The first device can thereby transmit a given application to the second device, to be deployed in a limited mode. The second device can deploy the application received from the first device in a limited mode, such as a mode limited to a MainContainer activation of the home screen of the application, in one non-limiting example. The second device can retrieve a specified component from the application and register it in the global scope of the rendering engine of the platform. For example, the specified component can be registered in a script such as VueJS.

In some embodiments, the SCD can cause a communication to be transmitted to the application indicating the completion of the downloading process causing the package to be registered in the global scope. If there is an error at one of the stages of the component loading process, the application will receive a flag about it. Subsequently, the SCD can permit a component of another application (e.g., the first device) to be deployed to the application with its integrated logic and infrastructure, which the application itself may not necessarily implement. The SCD enables sharing to occur in the runtime directly, specifically utilizing a through business component application where a business-functional layer of one application can be incorporated in another application, without the other application determining the internal ownership and logic. The SCD enables communications with a black box through input (input parameters)-output (component events) interfaces. These interfaces are compatible with the component owner. The owner of the application can reuse the component in his/her own applications or tasks.

Moreover, the same component can be used in the application itself. We suppose that the components were not made for sharing directly, but for the other application as they appear there. Components supposed to be shared further can be added to separate container. Separated flow for creating specific components is not required. This feature extends the functionality of the host by optimizing the use of overlapping functional layers of different applications. And there is no need to know the internal implementation of the component, what components it consists of, what logic it has, what network resources it accesses, for the user of the application it is a black box with public interfaces in the form of input properties for configuration, and outputs of various business events, in addition, there are events of the life cycle of the SC, which determine its current state (loading, loaded, there is an error). This process of sharing one platform application and using it in another is unique.

### BRIEF DESCRIPTION OF THE DRAWINGS/FIGURES

FIG. 1 depicts an example operating environment of a system for shared component development (SCD), according to some embodiments.

FIG. 2 depicts an SCD system, according to some embodiments.

FIG. 3 depicts a methodology for development and delivery of a microservice frontend in an SCD system, according to some embodiments.

FIG. 4 illustrates an example computing device, according to an example embodiment.

FIG. 5 depicts integration of an application in an SCD, according to some embodiments.

### DETAILED DESCRIPTION OF THE INVENTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Embodiments may be implemented in hardware, firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices, and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

It should be understood that the operations shown in the exemplary methods are not exhaustive and that other operations can be performed as well before, after, or between any of the illustrated operations. In some embodiments of the present disclosure, the operations can be performed in a different order and/or vary.

### BRIEF DESCRIPTION OF THE DRAWINGS/FIGURES

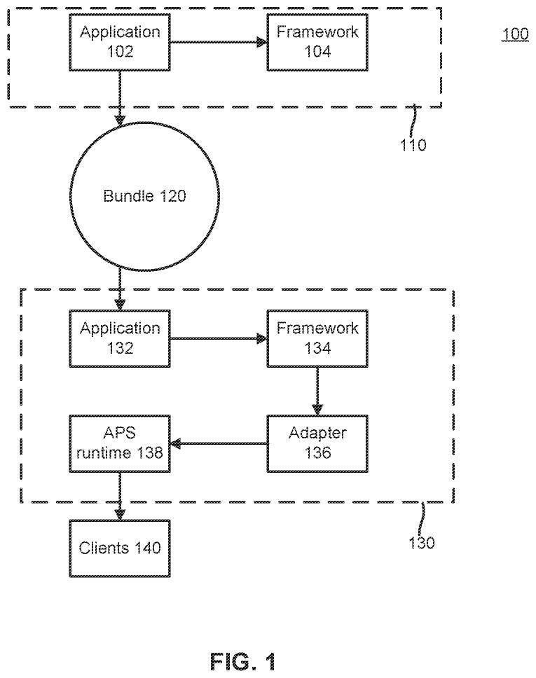

FIG. 1 depicts an example operating environment of a system for independent application design and deployment to a platform host, according to some embodiments.

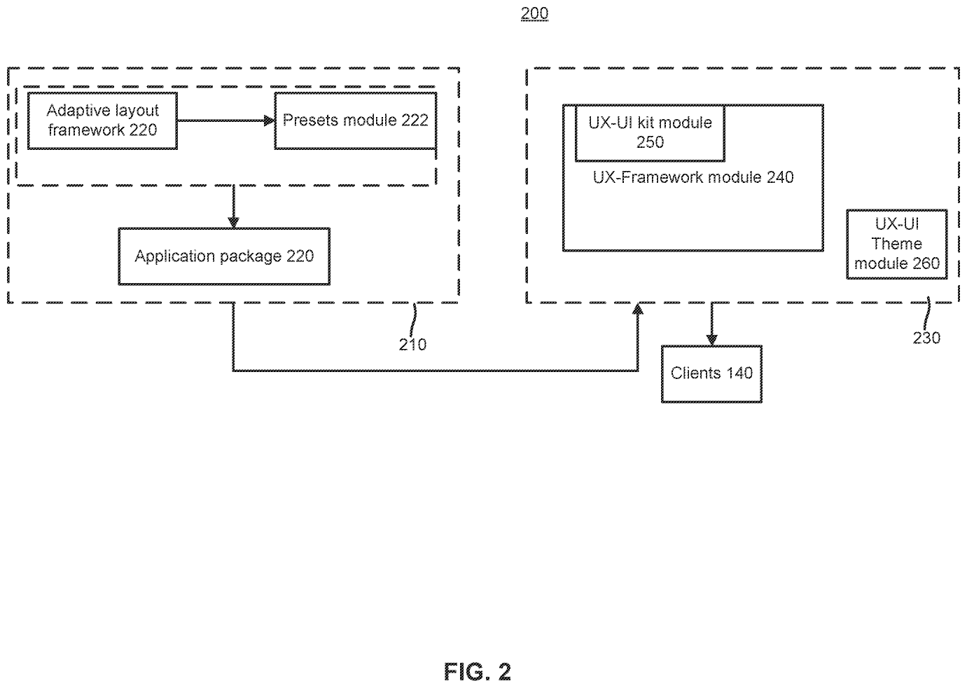

FIG. 2 depicts a system for independent application design and deployment to platform host, according to some embodiments.

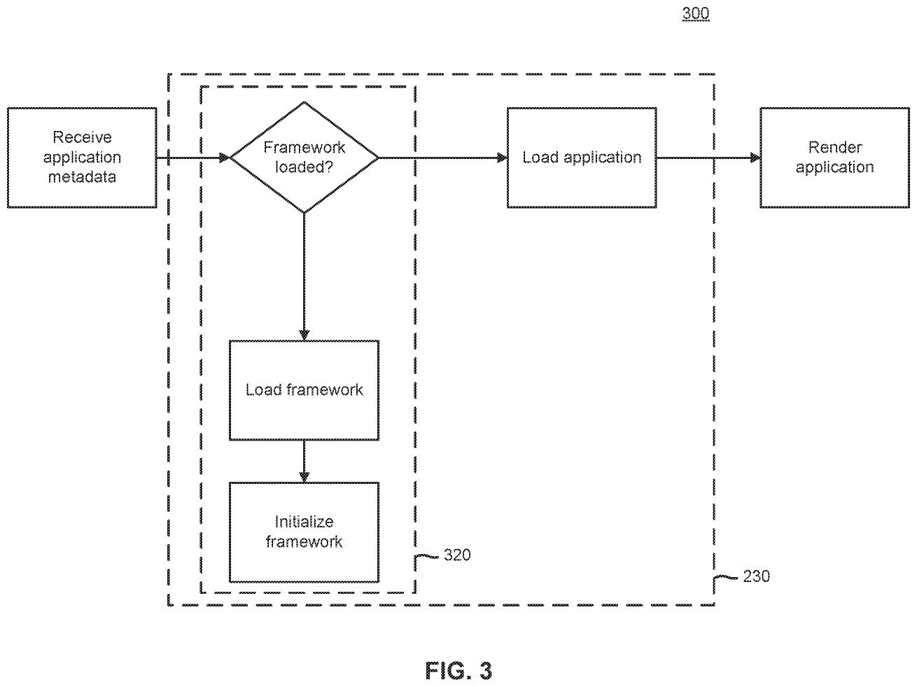

FIG. 3 depicts a methodology for deployment to platform host in an IADD system, according to some embodiments.

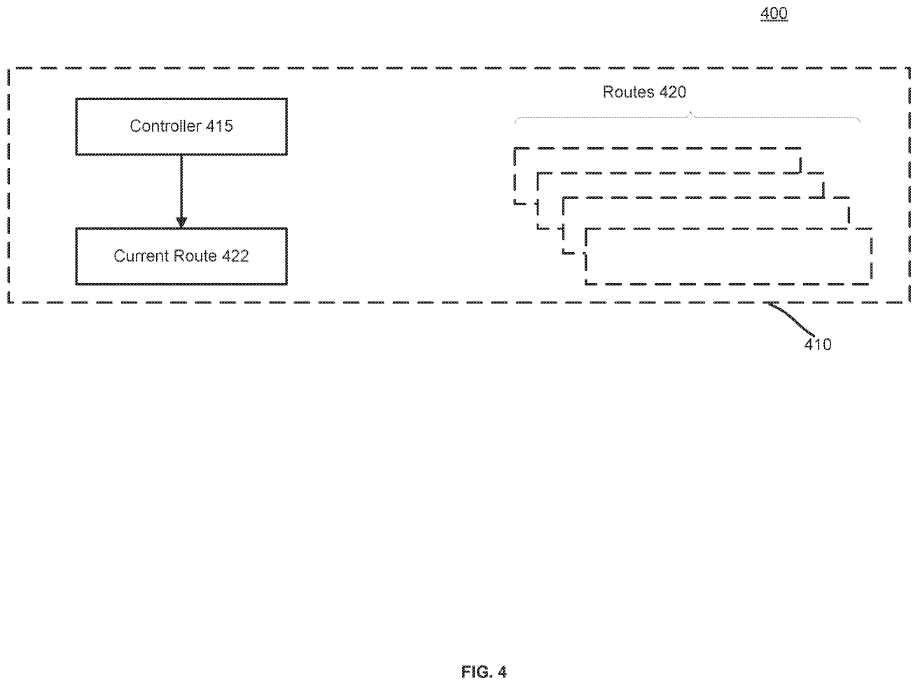

FIG. 4 depicts integration of an application rendered by a platform host in an IADD system, according to some embodiments.

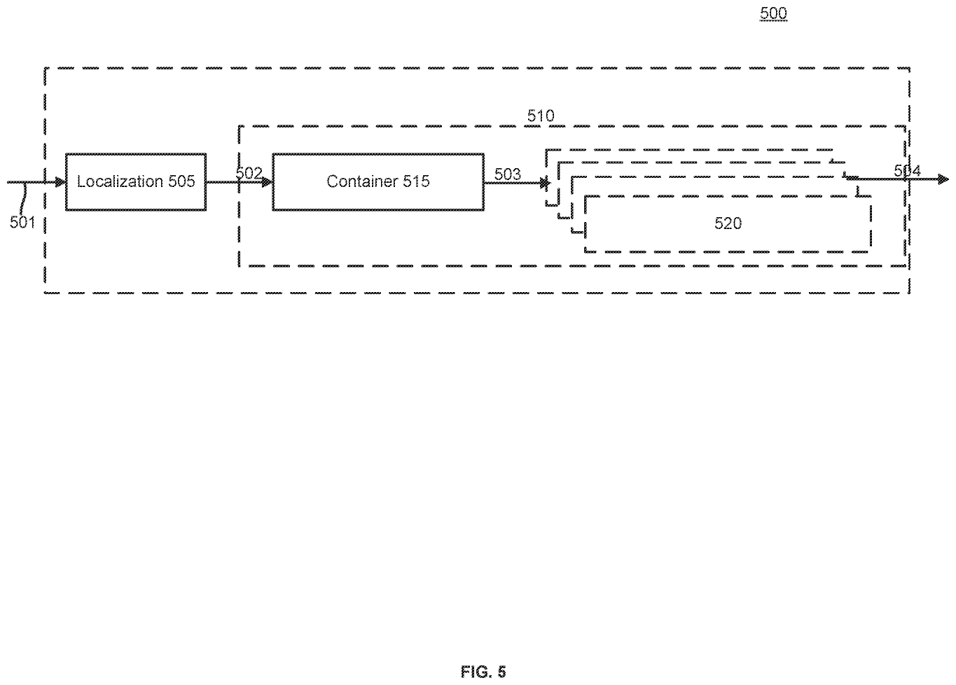

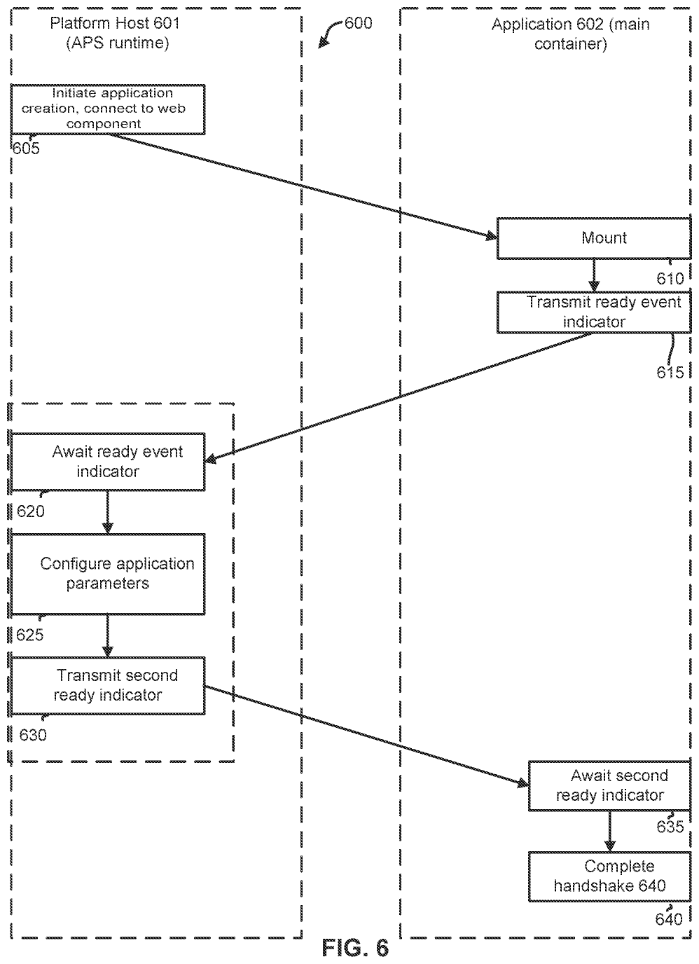

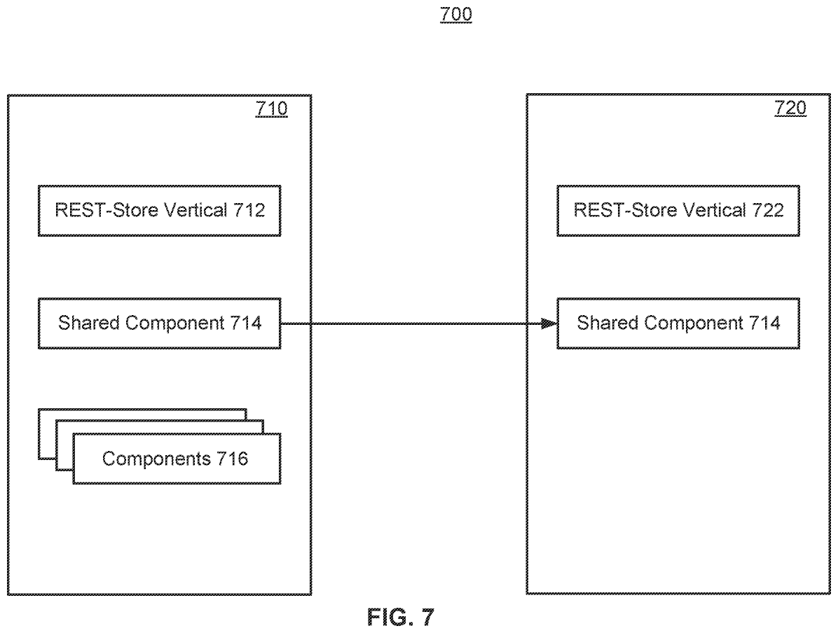

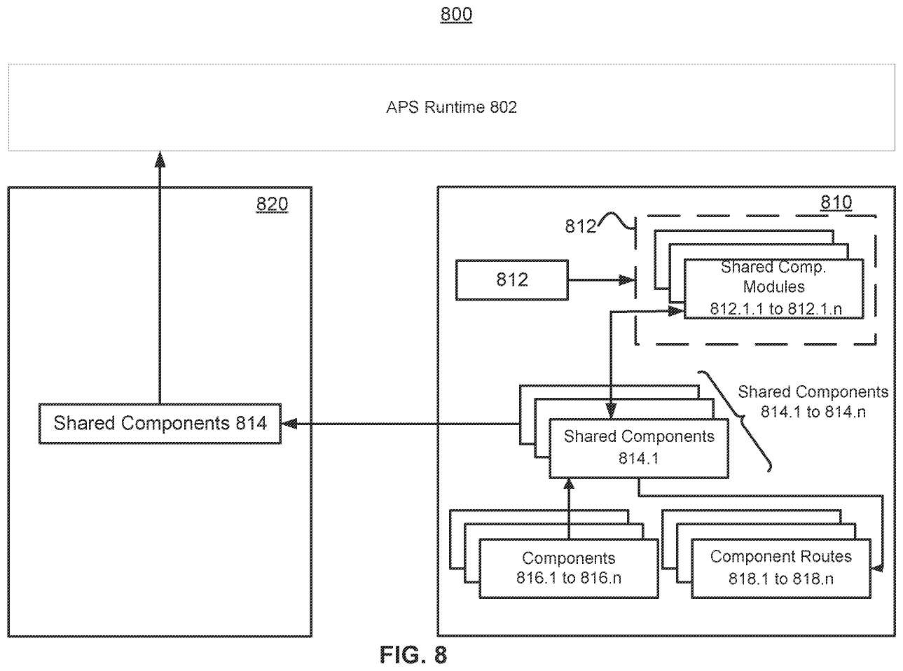

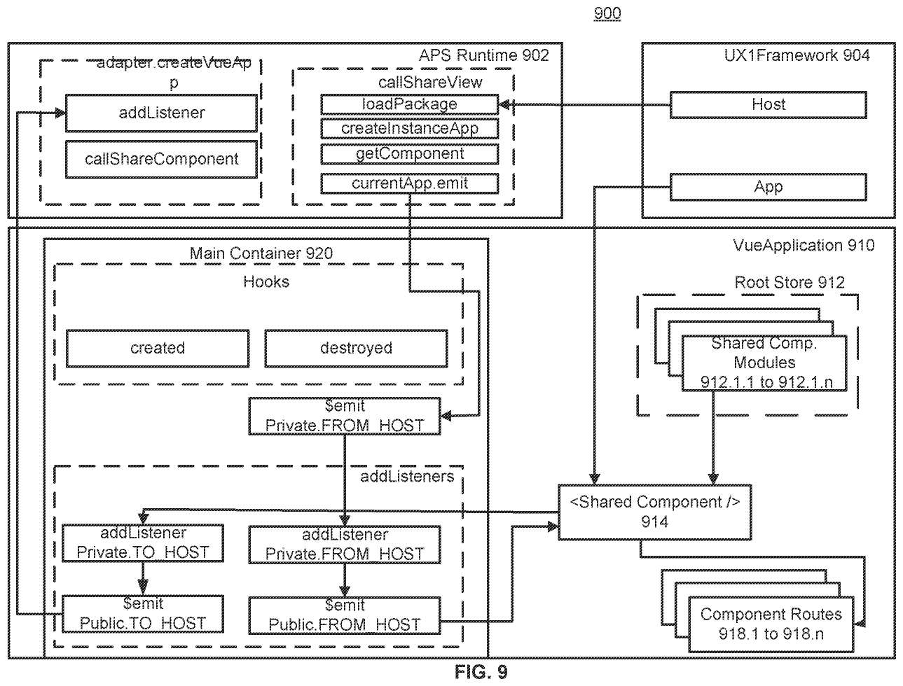

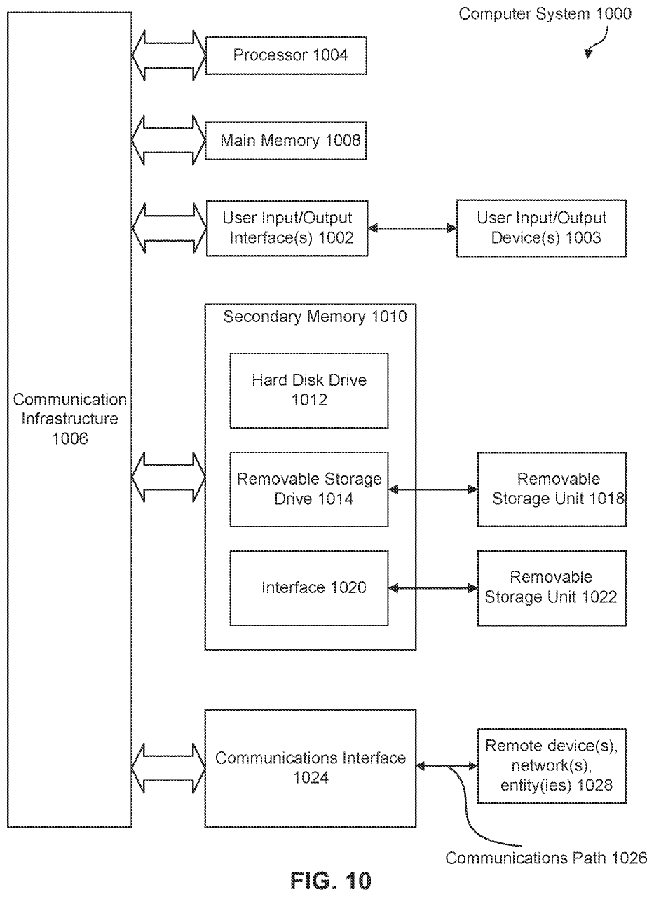

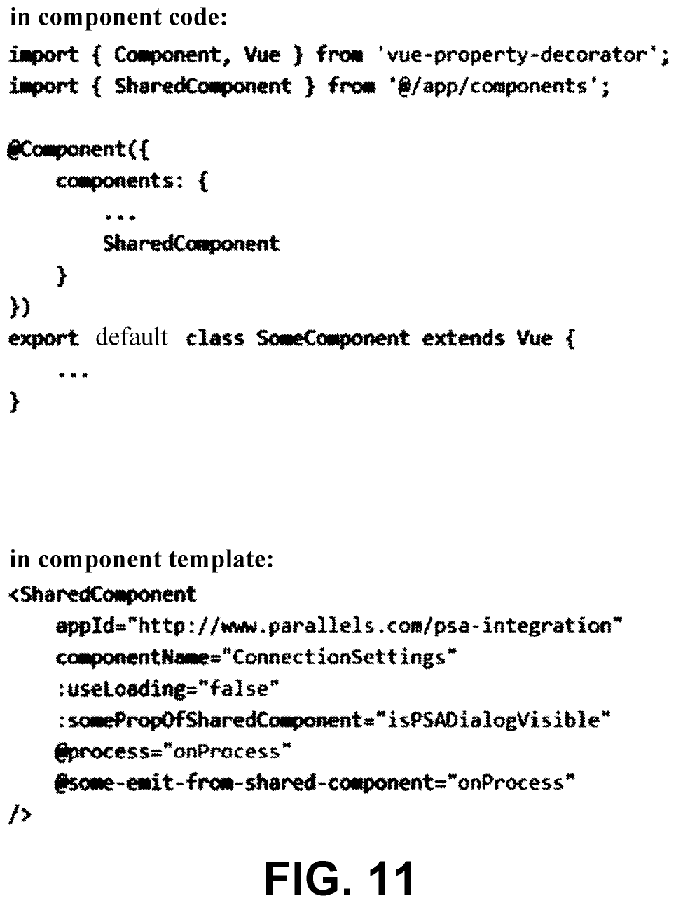

FIG. 5 depicts integration of an application rendered by a platform host in an IADD system, according to some embodiments.

FIG. 6 depicts a handshake methodology between a platform host and an application rendered by a platform host in an IADD system, according to some embodiments.

FIG. 7 depicts an example operating environment of a system for shared component development (SCD), according to some embodiments.

FIG. 8 depicts an SCD system, according to some embodiments.

FIG. 9 depicts a methodology for development and delivery of a microservice frontend in an SCD system, according to some embodiments.

FIG. 10 illustrates an example computing device, according to an example embodiment.

FIG. 11 depicts an object class of an application in an SCD, according to some embodiments.

### DETAILED DESCRIPTION OF THE INVENTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Embodiments may be implemented in hardware, firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices, and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

It should be understood that the operations shown in the exemplary methods are not exhaustive and that other operations can be performed as well before, after, or between any of the illustrated operations. In some embodiments of the present disclosure, the operations can be performed in a different order and/or vary.

### Application Creation

Embodiments described herein are directed to SCD methods and systems that can include a local microservices development mode that functions independently from a platform host, as described in detail in U.S. patent application Ser. No. 17/824,563, which is incorporated by reference in its entirety herein. IADD systems and methods are provided to address the above-mentioned technical problems. IADD systems and methods provide a specific layer for a vendor application that is local and independent from a platform host. This permits application development even having a non-persistent internet connection mode.

FIG. 1 illustrates an IADD system, according to some embodiments. As shown in FIG. 1, IADD systems 100 provides an ecosystem for several projects that can be separated based on, for example, functionality, responsibility and teams. IADD system 100 comprises development platform 110, bundle 120, and platform host (hosting cloud) 130.

As depicted, application creation at development platform 110 is separated of the platform host 130 itself. According to the exemplary embodiment, one or more frameworks associate an application of development platform 110 to a (production) application of platform host (130). That is, the framework(s) mutually connect the respective applications. The framework(s) comprise fundamental templates needed for application and testing at development platform 110. The framework(s) also comprise necessary specific means to integrate and deploy an application at a platform host (hosting cloud) 130.

In the exemplary embodiment, development platform 110 comprises application 102 and framework 104. Application 102 can include developer-written code. Framework 104 (e.g, VUE) can provide a software abstraction for providing generic functionality, that can be selectively adapted and implemented by application 102, thus providing application-specific software, such as for building user interfaces. Framework 104 can provide this abstraction built on top of standard programming languages (e.g., HTML, CSS, Javascript, etc.), providing a declarative and component-based programming model permitting efficient development of application-specific software, such as a user interface, whether simple or complex.

When IADD 100 is configured to deploy application 102, development platform 110 can generate an application bundle 120 that implements application 102 and framework 104 as a stand-alone, all in one container. According to the exemplary embodiment, a developer (e.g., a cloud application vendor or the like) can bundle application 102 and framework 104 according to the APS. The format of the bundle depends on the receiver, such as platform host 130. If the receiver is a standard WINDOWS desktop, then the software can be packaged using standard installers, and the file has a *.exe or *.msi extension. The installer includes unpacking rules, that includes a user dialog, writing into the registry, checking for updates, and so on. In the case of APS, the bundle can have a app.zip extension, and includes metadata, scripts and software code itself.

Exemplary development application 102 is transferred via application bundle 120 to platform host 130. An application 132 is generated inside the platform host 130. Platform host 130 comprises applications 132 and framework 134, adapter 136 and Application Packaging Standard (APS) module 138.

Adapter 136 connects framework 104/134 to the platform host at runtime, rendering interpret application 132 and framework 134 as a web application that provides an interface to a client via APS module 138.

APS module 138, also referred to as a controller or an application packaging controller, is a runtime module configured to distribute applications 132 to clients 140. One application can be delivered to one client or to multiple clients, as shown in FIG. 1. The APS is a specification defining a life cycle of application 132 in a cloud. The application's life cycle includes packaging, delivering to the cloud, integrating (and unpacking/deploying) into the cloud, distributing to clients, licensing, functionality, updates and deletion. The APS can include an Application Programming Interface (API) for accessing the APS functions from a program code or by http/https requests. The APS provides for efficient integration of SaaS web applications, such as application 132, into the cloud. According to the exemplary embodiment, in order for an application to function according to the APS, an APS module 138 (i.e., a controller) is integrated into a software hosting platform of a hosting cloud (platform host 140).

APS module 138 functions as a connector for controlling application(s) 132. APS module 138 receives application control requests and APS module 138 distributes the requests to appropriate scripts of application APS package 120. Application(s) 132 responses to clients 140 (outside of the cloud 100) are also processed by the controller module 110 and provided to clients 140. To integrate an application, APS module 138 applies framework 134 and can perform a validation of each of a format and structure of the application package (e.g., bundle 120), metadata of the metadata files, and at least one application programming interface (API) function of the vendor application.

FIG. 2 illustrates communication of the application with the platform host. As shown in FIG. 2, system 200 comprises local development application 210 and platform host 230. Local development application 210 comprises adaptive layout framework 220 (skeleton) and presets module 222, which can include fast development system presets. A preset can include, for example, one or more plugins, with some optional configuration. For example, a preset can contain plugins/options bundled together with other configuration options so that selecting a preset would mean selecting all those options.

For example, a default preset can include plugins (e.g., Babel, Typescript, Vuex, ESLint, Unit-Jest, etc.) as options/features. If a developer selects the default preset, local development application 210 can be created and install utility modules during project creation. Additionally or alternatively, a developer can also manually select desired options and plugins. A preset enables faster project creation. Presets module 222 operates in communication with adaptive layout framework 220 (skeleton).

As described above, the environment is prepared with the framework as a supplementary layer. The framework comprises everything required for a new application in isolation from the production stack, which can also be used for testing. As described in more detail below, an application can be compiled to a bundle file to be dynamically communicated to a platform host, enabling communication and implementation to a platform host to be optimized. The bundle file can be prepared as a set of asynchronous web components which can be communicated part-by-part upon opening a new page-representation of the application.

According to some embodiments, platform host 230 can comprise a user experience (UX) framework module 240, UX-user interface (UX-UI) kit module 250, and UX-UI theme module 260. UX framework module 240 comprises runtime components for operating in runtime, for local development and for testing. For example, platform host 230 can be an embodiment of platform host 130. In some embodiments, platform host 230 can include UX-UI kit module 250 that comprises means for creating ready form via mockups using a set of components (UI blocks), as a private part integrated into UX framework module 240. UX-UI theme module 260 provides a repository that comprises design tokens, global styles and override styles, i.e., elements representing design decisions and values.

Unlike conventional deployment processes, a hot module replacement (HMR) process can be performed to permit development of application 210 utilizing an environment of framework (e.g., corresponding to UX framework 240). Therefore, a developer can assess changes in application 210 without causing the application to be deployed at platform host 230.

Platform host 230 may receive a first indicator from IADD system 200. According to some embodiments, platform host 230 can be triggered, for example, in response to a prompt by IADD system 200, a request from a local development platform, a scheduled event, or the like, to request a status of local development application 210.

In response to receiving the first indicator, platform host 210 perform an operation of receiving development application 210. In some embodiments, platform host can request that development application 210 be transmitted and await the transmission. In some embodiments, the transmission is performed asynchronously.

After receiving a transmission that includes development application 210, platform host 230 can then perform processes to integrate the application. In some embodiments, platform host 230 continues a runtime of a current version of the application, which can be an APS runtime, and integrates the application minimizing downtime. For example, in some embodiments, platform host 230 can synchronously apply web components to integrate the application. In some embodiments, platform host 230 can provide a supplementary layer (e.g., framework 240) to a development platform. Framework 240 can include fundamental abstractions of an operating environment, to enable the development platform to be configured as required for development of an application in an isolated of stack form. Framework 240 provides foundational support for application architectures used for application development and testing.

A compiled bundle file can be provided to be dynamically downloaded to a platform host. File downloading to a platform host can thereby be optimized. The bundle file can be prepared as one or more asynchronous web component(s) that can be downloaded incrementally when a new page (i.e., route or representation of application) is rendered by an APS adapter.

At the same time, final bundle file comprises no code of primary vendor-libraries. This code is downloaded into a host from framework 240 directly. In this manner, application deployment can be performed minimizing a bundle file size, where the bundle file comprises specific business layer code only. The IADD system and methodology permits organization of web components for optimal platform host deployment. Web components provide a new layer of isolated applications independent of the platform host.

Accordingly, new applications are configured by IADD systems and methods to exist in parallel with old applications, and the applications do not influence each other. That is, new and old applications coexist with optimal platform host load.

Providing supplementary features in a framework (e.g., adaptive layout framework 220) for local application development enables convenient debugging processes that can include the use of specific real-time means, such as utility tools that help a developer in developing applications (for example, VUE DEVTOOLS).

Due to the independent application creation mode, faster application creation can be achieved due to the absence of the need to send code to the stack every time to check it, so that the set business goals are achieved faster, which was not the case before. Such process organization bring convenience into process, time saving. Additional advantages include deployment of more reliable applications and patches. The same environment is prepared by the framework for runtime and for testing and for local development. At the framework level each potential runtime use case is considered, and development is possible by focusing on a specific business layer. In this manner, a smoother transition from an old workflow to a new workflow can be achieved, permitting incremental development to be performed while minimizing unnecessary downtime.

### Integration

FIG. 3 illustrates IADD methodology 300 to deploy a new workload into integrated at an APS runtime. Utilizing a specific description parameter, new applications can be deployed utilizing a framework that comprise means for APS integration. According to embodiments, IADD method 300 enable old and new applications to work in parallel concurrently.

As shown in FIG. 3, at operation 310, platform host 230 can receive application metadata corresponding to an application, such as an APS application. At operation 320, platform host 230 determines whether or not a framework is loaded. Based on the determination, platform host (e.g., at UX framework module 240) can retrieve and initiate a framework as a supplementary layer that can include fundamental abstractions of an operating environment. Therefore, platform host 320 is configured to maintain in runtime supplemental support that includes support for application architectures being developed. These supplementary features enable convenient debugging processes and minimize downtime of production applications, such as an APS runtime.

FIG. 4 illustrates IADD system 400 comprising a container as a controller representing the application utilizing a set of web components. As shown in FIG. 4, to rendered application 410 to a client (e.g., client 140), application 410 represents itself as the set of web components, such as routes 420.

System 400 comprises one or more container(s) that function as controller 415 of application 410. Controller 415 acts as an upper layer of one or more web component(s) configured to organize the flow and operation of other web components, i.e., routes 420. Routes 420 are web components that can be provided having an organization implemented by controller 415. Route array 420 comprises one or more routes, providing a library for page navigation (routes) in applications, e.g. web applications. Each route 420 is another view that the web application 410 can render (e.g., current route 422) or hide as requested, for example, by user navigation. Application 410 can include specific representations having an internal physical structure. Therefore, application 410 itself represents web components, i.e., routes 420, that are configured to control other web components.

FIG. 5 illustrates a browser application deployment process 500. As shown in FIG. 5, browser application deployment process 500 can include operation 501 in which a localization scheme 505 is initialized to configure a web component.

At operation 502 a web component configured by localization scheme 501 is integrated by controller 510 to a container 515. For example, an initial (i.e., a home) route can be integrated in container 515.

At operation 503 the application deployment can include an operation of splitting a bundle into application bundle chunks 520. Operation 503 can include integration of each chunk 520, which can comprise or correspond to a specific web route component.

At operation 504, upon completion of adding each web component to a browser, initial application life cycle can proceed. Operation 504 can include rendering the configured application for clients (e.g., clients 140).

### Platform Host Hand-Shaking

FIG. 6 illustrates a process 600 for performing a new deployment of an application (which can be, for example, an embodiment of application 102 deployed as application 132, application 210, 410, etc.). Process 600 can include a hand shake between an application provided by a local development platform (e.g., platform 110) and a platform host (e.g., platform host 130) to cause deployment of the application to the runtime. As shown in FIG. 6, after the application is developed, it can be deployed in a platform host.

At operation 605, platform host 601 can perform operations corresponding to web component creation, for example, transmitting a connected web component to an application (e.g., a container such as a main container).

At operation 610, the connected web component is mounted at container 602. Operation 610 can include initiation of a handshake between container 602 and platform host 601.

At operation 615, data including a first indicator, e.g., a flag, can be communicated between container 602 and platform host 601 to indicate that the application is ready for deployment.

At operation 620, platform host 601 awaits communication of the first indicator. Upon receiving the first indicator, platform host 601 can be configured to begin a deployment process, which can be an embodiment of deployment process 500, etc.

At operation 625, upon receiving the first indicator, platform host 601 can be configured to integrate application parameters corresponding, as described above.

At operation 630, after configuring application parameters platform host 601 can communicate data that includes a second indicator to indicate that the application is deployed.

At operation 635, application awaits communication of the second indicator. Upon receiving the second indicator, container 602 sets parameter of the application (e.g., a “public” parameter) at operation 640 to permit rendering of the application by a runtime process. Operation 640 can include, for example, setting a parameter to permit an APS runtime to be rendered by platform host 130 to clients 140.

### Event System

According to exemplary embodiments, an event-based methodology of system interactions is provided to enable coordination between a vendor application development platform and a platform host. The event-based methodology of system interactions comprises one or more processes to create an event-controllable specific system, which can be an embodiment of system 100, for example. The event-based methodology of system interactions permits coordination to be achieved without rigid communications between vendor application development platform and a platform host, permitting a vendor application to be changed independently. This event-based methodology provides an advantage over conventional processes that require rigid dependence between a development platform and a platform host, while allowing the local development and host runtime environments to be managed as predictable operations.

According to some embodiments, interaction between a host platform and a vendor application development platform additionally permits coordination of one or more platform framework(s) between a platform host and a development platform. According to exemplary embodiments, these interactions can include (A) vendor application development platform sending events involving one or more framework(s) to a platform host; and (B) the vendor application development platform subscribing to platform host events. In some embodiments, (1) a private event involving one or more framework(s) can be transmitted from an application to a host platform, e.g., an internal use event; (2) a private event can be transmitted from the platform host to the application, e.g., an internal use; (3) a public event involving one or more framework(s) can be transmitted from the application to a platform host, e.g., a public use by a UX1 Framework developer; and (4) a public event can be transmitted from a platform host to a vendor application development platform to, e.g., including an abstraction for providing generic functionality, that can be selectively adapted and implemented by application 102.

This event-based methodology can be configured to perform fundamental systems communications. Such communications can include, for example, information utilized for routing, notification, sending analytics data (such as GOOGLE analytics data), etc. event-based methodology can be configured to perform sharing components involving application features.

The solution made is flexible and can be extended on any number of new features (system communications) with no restriction. The two-way system interaction between the platform host and the application takes place using a proprietary framework system, that can include providing one or more web component(s) configured to organize interaction at a native browser level. According to some embodiments, an IADD event system permits an application in development and a platform host to change independently without requiring a rigid bundle or dependency.

### Shared Component Integration

In some embodiments, SCD methods and systems can additionally include processes for mockup and tokenization, i.e., tokens maintained in a unified library of widgets, for example, supported independent from a specific application and available to a frontend developer. In some embodiments, SCD methods and systems can further include interaction of microservice with the external world. For example, SCD methods and systems can enable communication between the shared component in development with other microservices, the host itself, the Representational State Transfer (REST) request system, unit testing, application debugging, simulation of communication before host deploys, etc.

Shared component Development (SCD) systems and methods are provided to address the above-mentioned technical problems. SCD systems and methods provide a specific layer for a vendor microservice application frontend that provides all resources needed to a frontend developer to return an application as an integrated part of the process. The SCD facilitates task resolution effectively organizing and enabling communication between different components of web application creation process blocks. The SCD systems and methods enable timely application readiness, and improvements in testing and debugging. Thus, better operability of end user applications is achieved with reduced costs of application development. The frontend developer is enabled to specifically combine software layers and perform debugging process, deployment while minimizing time and effort spent developing a new microservice. SCD systems and methods include specific REST-Store vertical details to provide a more effective frontend-backend connection of the microservice, allowing the developer to use a single compilation of code for such modes as local development (with emulated data transport level), unit testing and runtime (i.e., production).

FIG. 7 illustrates an SCD system, according to some embodiments. As shown in FIG. 7, SCD systems 700 provides an ecosystem for several projects that can be separated based on, for example, functionality, responsibility and teams. SCD system 700 comprises a first device 710 and a second device 720.

First device 710 can include a first REST-Store Vertical, Shared Component (SC) 714 and additional components 716. Second device 720 can include a second REST-Store Vertical, and SC 714, as described above.

As described above, in each application, a system component (SC 714) appears that allows use of any tiled component of any application. To achieve this, SCD 700 enables two main parameters to be communicated between first device 710 and second device 720: the ID of the application and the name of the component that is intended to be used/shared. In implementation, additional any supported parameters can be communicated to configure the SC, and an application can subscribe to any events of the component.

As shown in FIG. 8, SC 714 has its own lifecycle. SCD 800 can commence a step that performs a component download process. First device 710 can receive from the second device 820 a request to download the application to the second device. First device 710 can transmit SC 714 to second device 820, to be deployed in a limited mode. Second device 710 can deploy SC 714 received from first device 710 in a limited mode, such as a mode limited to a MainContainer activation of the home screen of the application, in one non-limiting example. Second device 820 can retrieve SC 814 from an application of first device 810 and register it in the global scope of the rendering engine of the platform to be implemented based on a module 812 (812.1 to 812.n) retrieved from a root service 812. SC 814 can implement (e.g., in MainContainer) one or more components 816.1 to 816.n retrieved from component route store 818 (routes 818.1 to 818.n). If SC 814 is required but not present, a developer can simply specify the component storage or folder and apply for it further/share, as it is shown below.

The specified component can be registered in a script such as VueJS. SC 814 allows use of any tiled component of any application. In some embodiments, the SCD can cause a communication to be transmitted to the application indicating the completion of the downloading process causing the package to be registered in the global scope. If there is an error at one of the stages of the component loading process, the application will receive a flag about it. Subsequently, SCD 800 can permit a component of another application (e.g., first device 810) to be deployed to the application with its integrated logic and infrastructure, which the application itself may not necessarily implement. The SCD enables sharing to occur in a runtime 802 directly, specifically utilizing a through business component application where a business-functional layer of one application can be incorporated in another application, without the other application determining the internal ownership and logic. SCD 800 enables communications with a black box through input (input parameters)-output (component events) interfaces. These interfaces are compatible with the component owner. The owner of the application can reuse the component in his/her own applications or tasks.

Moreover, the same component can be used in the application itself. We suppose that the components were not made for sharing directly, but for the other application as they appear there. Components supposed to be shared further can be added to separate container. Separated flow for creating specific components is not required. This feature extends the functionality of the host by optimizing the use of overlapping functional layers of different applications. And there is no need to know the internal implementation of the component, what components it consists of, what logic it has, what network resources it accesses, for the user of the application it is a black box with public interfaces in the form of input properties for configuration, and outputs of various business events, in addition, there are events of the life cycle of the SC, which determine its current state (loading, loaded, there is an error). This process of sharing one platform application and using it in another is unique.

The route store 818 acts as an upper layer of one or more web component(s) configured to organize the flow and operation of other web components, i.e., routes 818.1 to 818.3n. Routes 818 are web components that can be provided having an organization implemented by controller (e.g., controller 415). Route array 818 comprises one or more routes, providing a library for page navigation (routes) in applications, e.g. web applications. Each route 818 is another view that the web application (e.g., 602) of first device 810 can render (e.g., current route 812) or hide as requested, for example, by user navigation. Application 814 can include specific representations having an internal physical structure. Therefore, application 814 itself represents web components, i.e., routes 818, that are configured to control other web components.

Route store 818 is configured to connect, for example via an API, REST-Store layer 630 and function as an upper layer of one or more web component(s) configured to organize the flow and operation of other web components. REST layer 712 can be configured to connect to a microservice backend application and an Application Packaging Standard (APS) bus. REST layer 712 can be configured to perform a data request and retrieve data to microservice backend application and Application Packaging Standard (APS) bus.

This environment is prepared with a supplementary framework (FW) layer. The FW comprises everything required for a new application in an isolated of stack form. A same, singular FW can be used for the creation of unit tests, additionally.

New application integration can further include creation of a compiled bundle file to be dynamically downloaded to a platform host. File downloading to a platform host is also optimized. Said file is prepared as set of asynchronous web components which can be downloaded part-by-part at time of opening new page-representation of application. At the same time, final bundle file comprises no code of primary vendor-libraries. This code is downloaded into a host from FW directly. In some embodiments, a final bundle file comprises specific business layer code only providing minimal bundle file size. Such process organization provides optimal and effective platform host deployment.

FIG. 9 depicts SCD system 900 that includes a lifecycle of SC 814/914 (shown as a SC call 914) in relationship to main container 920. As shown in FIG. 9, in one embodiment main container 900 can include hooks, for example, configured to react to events and initiate or shutdown a process. Main container 900 can further include addListener events to handle processes related to vueApplication 910 including a shared component call 914.

SC call 914 can invoke a shared component which can be an embodiment of SC 814, from UX1 Framework 904. An example SC call 914 is depicted in FIG. 11 (e.g., SC script 1100). Root store 912 can be an embodiment of root store 812 and component routes 918.1 to 918.n can be embodiments of component routes 818.1 to 818.n, discussed above. For example, SC 914 can implement (e.g., in MainContainer 920) one or more components 816.1 to 816.n retrieved from component route store 818 (routes 818.1 to 818.n). If SC 814 is required but not present, a developer can simply specify the component storage or folder and apply for it further/share, as it is shown below.

As shown in FIG. 9, specified component can be registered in a script, for example, VueJS. SC 914 invokes use of SC 814 in any tiled component of any application. In some embodiments, the SCD can cause a communication to be transmitted to application indicating the completion of the downloading process causing the package to be registered in the global scope. If there is an error at one of the stages of the component loading process, the application 910 receives a flag about it. As above, SCD 900 can then permit a component of another application to be deployed to the application with its integrated logic and infrastructure, which the application itself may not necessarily implement. SCD 900 enables sharing to occur in a runtime 902 directly, specifically utilizing a through business component application where a business-functional layer of one application can be incorporated in another application, without the other application determining the internal ownership and logic.

SC 914 can include specific representations having an internal physical structure. Therefore, application 914 itself represents web components, i.e., routes 918, that are configured to control other web components.

Various embodiments may be implemented, for example, using one or more computer systems, such as computer system 1000 shown in FIG. 10. One or more computer systems 1000 may be used, for example, to implement any of the embodiments discussed herein, as well as combinations and sub-combinations thereof. For example, computer system 1000 can be used to implement system 100 for shared component application development and deployment, including framework 700 of FIG. 7, and/or any other implementations of the disclosed embodiments.

Computer system 1000 may include one or more processors (also called central processing units, or CPUs), such as a processor 1004. Processor 1004 may be connected to a communication infrastructure or bus 1006.

Computer system 1000 may also include user input/output device(s) 1008, such as monitors, keyboards, pointing devices, etc., which may communicate with communication infrastructure 1006 through user input/output interface(s) 1002.

One or more of processors 1004 may be a graphics processing unit (GPU). In some embodiments, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), may cause such data processing devices to operate as described herein.

It should be understood that the operations shown in the exemplary methods are not exhaustive and that other operations can be performed as well before, after, or between any of the illustrated operations. In some embodiments of the present disclosure, the operations can be performed in a different order and/or vary.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments but should be defined only in accordance with the following claims and their equivalents.

What is claimed is:

1. A method for creating and integrating a shared component into a host platform, wherein the microservice application of the host platform comprises the shared component and a microservice application, the method comprising:
communicating, to a UX development platform, a request corresponding to shared component (SC) application;
communicating the SC to a microservice application development platform, as a microservice shared component;
generating, by the microservice application development platform, a microservice shared component package based on a shared component; and
integrating the microservice shared component package, wherein an application is integrated utilizing the microservice shared component based on the request.

2. The method of claim 1, wherein the generating the microservice shared component further comprises: communicating an error associated with the request to deploy the SC.

3. The method of claim 1, wherein the generating the microservice shared component further comprises: sharing the SC to a runtime of a microservice application.

4. The method of claim 1, wherein the generating the microservice shared component further comprises: generating a business-functional layer of one application implemented in another application.

5. The method of claim 1, wherein the generating the microservice shared component further comprises: deploying the SC in a limited mode of the microservice application.

6. The method of claim 1, wherein the generating the microservice shared component further comprises: deploying the SC in a MainContainer activation of a home screen of the microservice application.

7. The method of claim 1, wherein the generating the microservice shared component further comprises: registering the SC in a global scope of a rendering engine of a microservice application platform.

8. A system for creating and integrating a shared component into a host platform, wherein the microservice application of the host platform comprises the shared component and a microservice application, the system comprising: a processing system having one or more processors that execute computer-executable instructions that cause the processing system to:
communicate, to a UX development platform, a request corresponding to shared component (SC) application;
communicate the SC to a microservice application development platform, as a microservice shared component;
generate, by the microservice application development platform, a microservice shared component package based on a shared component; and
integrate the microservice shared component package, wherein an application is integrated utilizing the microservice shared component based on the request.

9. The system of claim 8, wherein the generating the microservice shared component further comprises: communicating an error associated with the request to deploy the SC.

10. The system of claim 8, wherein the generating the microservice shared component further comprises: sharing the SC to a runtime of a microservice application.

11. The system of claim 8, wherein the generating the microservice shared component further comprises: generating a business-functional layer of one application implemented in another application.

12. The system of claim 8, wherein the generating the microservice shared component further comprises: deploying the SC in a limited mode of the microservice application.

13. The system of claim 8, wherein the generating the microservice shared component further comprises: deploying the SC in a MainContainer activation of a home screen of the microservice application.

14. The system of claim 8, wherein the generating the microservice shared component further comprises: registering the SC in a global scope of a rendering engine of a microservice application platform.

15. A computer program product for creating and integrating a shared component into a host platform, wherein the microservice application of the host platform comprises the shared component and a microservice application, the computer program comprising computer-readable program code capable of being executed by at least one processor when retrieved from a non-transitory computer-readable medium, the program code comprising instructions configured to cause the processor to:
communicate, to a UX development platform, a request corresponding to shared component (SC) application;
communicate the SC to a microservice application development platform, as a microservice shared component;
generate, by the microservice application development platform, a microservice shared component package based on a shared component; and
integrate the microservice shared component package, wherein an application is integrated utilizing the microservice shared component based on the request.

16. The computer program product of claim 16, wherein the generating the microservice shared component further comprises: sharing the SC to a runtime of a microservice application.

17. The computer program product of claim 16, wherein the generating the microservice shared component further comprises: generating a business-functional layer of one application implemented in another application.

18. The computer program product of claim 16, wherein the generating the microservice shared component further comprises: deploying the SC in a limited mode of the microservice application.

19. The computer program product of claim 16, wherein the generating the microservice shared component further comprises: deploying the SC in a MainContainer activation of a home screen of the microservice application.

20. The computer program product of claim 16, wherein the generating the microservice shared component further comprises: registering the SC in a global scope of a rendering engine of a microservice application platform.
